(19) United States
(12) Patent Application Publication
(10) Pub. No.: US 2010/0141222 A1
(43) Pub. Date: Jun. 10, 2010

(54) LOAD TRANSIENT SENSING CIRCUIT FOR A POWER CONVERTER

(76) Inventor: Qian Ouyang, Hangzhou (CN)

Correspondence Address: PERKINS COIE LLP;PATENT-SEA, P.O. BOX 1247, SEATTLE, WA, 98111-1247, US

(21) Appl. No.: 12/634,021

(22) Filed: Dec. 9, 2009

(30) Foreign Application Priority Data
Dec. 10, 2008 (CN) 200810184283.4

(51) Int. Cl. G05F 1/10

(52) U.S. Cl. 323/234

(57) ABSTRACT

The present invention provides a circuit for sensing a load transient of a power converter. The circuit comprises an input terminal coupled to the voltage output terminal of the power converter through a resistor. The circuit further comprises a comparator for comparing an input voltage with a reference voltage to generate a load transient signal to control output voltage parameters of the power converter. The circuit has a simple circuit structure and can promptly sense the load transient of the power converter to thereby control various output parameters.

### CROSS-REFERENCE TO RELATED APPLICATION(S)

This application claims the benefit of priority to Chinese Patent Application No. 200810184283.4, filed Dec. 10, 2008, which is incorporated herein by reference in its entirety.

### TECHNICAL FIELD

The embodiments described below relate to power converters, and more particularly, to a load transient sensing circuit for a Buck power converter.

### BACKGROUND

With the functions of modern electronic devices getting more complicated, power supplies for powering the same often suffer large and fast load transients. When a load transient occurs, a power supply is required to have a good load transient response to promptly regulate the power supply circuit so as to obtain a smooth output voltage and a higher efficiency.

The timeliness of sensing a load transient is a key factor that affects the speed of the transient response of a power supply. A transient response of a power supply involves regulating the power supply circuit to smooth the output voltage during the load transient or regulating the system frequency promptly to improve the system efficiency according to a transient, etc. In most power supply systems, power converters are indispensably used as power supplies for various electric and electronic devices.

A traditional approach to smooth the output voltage of a power converter is to use the adaptive voltage position (AVP) control technology. The AVP control technology can obtain a relatively stable output voltage in response to a load current transient, and moreover, the AVP control technology can use a smaller output capacitor. The AVP control technology is applied in power converters for powering high-performance CPUs, communication equipment, DSPs, image processors etc. where large current transient load points exist. The basic control method of AVP is to control the output voltage in a range between the output voltage under no load condition and the output voltage under full load condition.

The active droop mode control or the current mode control can be used to realize the AVP control technology. But for the common active droop mode control and the common current mode control, the slew rate of the compensation voltage is limited by the system bandwidth and the process technology of the operational amplifiers when a load transient occurs. Thus the output voltage cannot respond promptly, causing a large increase or decrease in the output voltage. Further, the RS flip-flop used in an AVP system introduces an extra delay under the current mode control.

FIG. 1 shows a circuit diagram illustrating a prior-art power converter controlled by an active droop voltage. The power converter is equivalent to an ideal voltage source in series with a resistor and the AVP control of the power converter is realized by sampling the load current thereof. As shown in FIG. 1, the circuit samples an inductor current I_{L} and converts it into an active droop voltage V_{droop} though a resistor (link A). The droop voltage V_{droop} is then compensated to provide a compensated output voltage. An error amplifier receives the compensated output voltage and compares it with a reference voltage V_{ref} to thereby produce a compensation voltage which is then fed into a driving circuit to produce a load transient signal for regulating the output voltage. The AVP circuit controls the output voltage between a no load voltage and a full load voltage and reduces the overshoot voltage during a load transient. However, the AVP circuit is limited by the slew rate of the compensation voltage and moreover, the regulation steps thereafter can result in hysteresis. Therefore, the AVP circuit fails to regulate the output voltage promptly. In order to compensate the abrupt change of the output voltage quickly, there is a need to sense the load transient promptly so that the abrupt change of the output voltage can be compensated by more direct measures.

The prior-art load transient sensing method often senses the compensation voltage. FIG. 2 shows a circuit diagram illustrating a power converter having a prior-art load transient sensing and control circuit. As shown in FIG. 2, the power converter has a sensing and control circuit 20 which receives the compensation voltage V_{c} and couples said compensation voltage V_{c} to a capacitor C1 via a switch K₃. Switch K3 is turned on or off by a clock signal T and the capacitor C1 stores the compensation voltage V_{c}. A comparator 21 compares the current compensation voltage V_{c} with the compensation voltage V_{c} of last sensing period stored in capacitor C1 to generate a load transient signal S in response to the change of V_{c}. Meanwhile, a phase shift circuit regulates the pulse phase of the crystal oscillator in the PWM (Pulse Width Modulation) generating circuit according to the load transient signal S, so that the regulation of the output voltage is achieved. The method described above has a relatively large hysteresis due to obtaining the load transient signal by comparing the compensation voltages of different clock periods and also has a bad transient response due to the limitation of the slew rate of the compensation voltage. Other load transient sensing methods sense an output current or an output voltage and determine a load transient by comparing the difference of the sensed value over a certain time interval. The methods require both a sensing and sampling circuit and a determination circuit at one time, resulting in a rather complex circuit structure. Therefore, it is desirable to design a circuit that can sense the load transient promptly and also has a simple structure.

### BRIEF DESCRIPTION OF THE DRAWINGS

The accompanying drawings are included to provide a further understanding of the invention, and are incorporated in and constitute a part of this specification. The drawings illustrate embodiments of the invention and together with the description, serve to explain the principle of the invention. In the drawings,

FIG. 1 shows a circuit diagram illustrating a prior-art power converter controlled by an active droop voltage;

FIG. 2 shows a circuit diagram illustrating a prior-art power converter having a load transient sensing and control circuit;

FIG. 3 shows a diagram illustrating the load transient sensing waveform in a power converter using an active droop control circuit of the present invention.

FIG. 4 shows a schematic diagram of a load transient sensing circuit using an active droop control circuit according to an embodiment of the present invention.

FIG. 5 shows a sensing circuit diagram illustrating the load transient with an active droop control circuit according to another embodiment of the present invention.

FIG. 6 shows a waveform diagram illustrating a load transient sensing method without using an active droop mode control of the present invention.

FIG. 7 shows a sensing circuit diagram illustrating the load transient without an active droop control function according to an embodiment of the present invention.

FIG. 8 shows a sensing circuit diagram illustrating the load transient without an active droop control according to another embodiment of the present invention.

FIG. 9 shows a block diagram illustrating the load transient sensing circuit applied in frequency control according to the present invention.

FIG. 10 shows a circuit diagram illustrating the frequency control circuit shown in FIG. 9;

FIG. 11 shows a structural diagram illustrating the load transient sensing circuit applied in an overshoot eliminating device of a Buck converter.

FIG. 12 shows a logic control circuit diagram illustrating the auxiliary control circuit shown in FIG. 11.

### DETAILED DESCRIPTION

In general, the terms used herein are defined as follows: the power converter of the present invention is a DC-DC step-down (Buck) converter, or a converter of other types such as a Boost converter or a Buck-Boost converter. The present invention can be used to control a single-phase power converter or a multiphase power converter.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

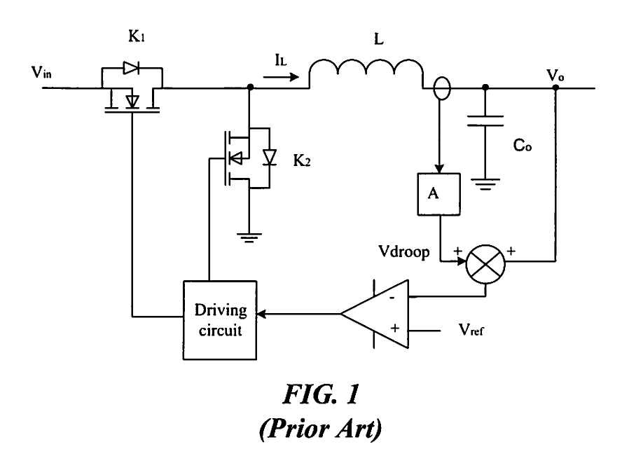

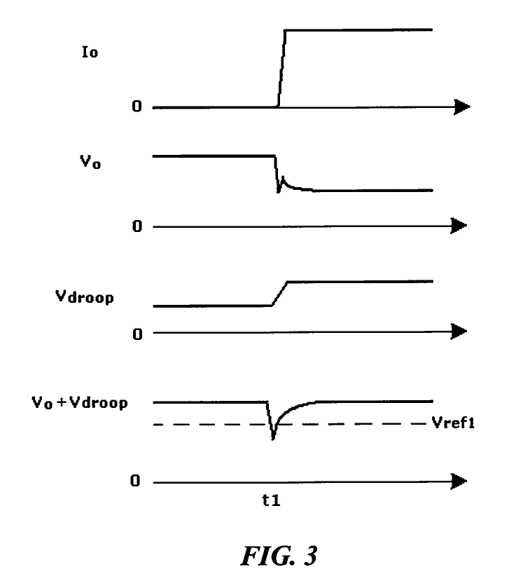

FIG. 3 shows a diagram illustrating the load transient sensing waveform in a power converter using an active droop control circuit of the present invention. The signals shown in FIG. 3 are the load current Iₒ, the output voltage Vₒ, the active droop voltage V_{droop} and Vₒ+V_{droop}. Iₒ is the inductor sampled current I_{L} as illustrated in FIG. 1 for a single-phase power converter and is the sum Iₛᵤₘ of n-phase inductor sampled currents I_{L1}, I_{L2} . . . , L_{Ln}, namely, Iₒ=Iₛᵤₘ=I_{L1}+I_{L2}+ . . . +I_{Ln} for a multiphase (n-phase) power converter. At time t1, Iₒ steps up from zero to a constant value. In the power converter with an active droop control circuit, the step-up of Iₒ results in a change of Vₒ as shown in FIG. 3, that is, Vₒ decreases rapidly and recovers to a steady state after an oscillation. V_{droop} is an active droop voltage produced by the active droop control circuit which becomes stable after a ramp increase due to the step-up of the load current Iₒ. Superimposing Vₒ with V_{droop}, a waveform of Vₒ+V_{droop} is obtained. As shown in FIG. 3, a downward spike appears in Vₒ+V_{droop} when the load current Iₒ steps up from one value to another.

Comparing Vₒ+V_{droop} with a reference voltage V_{ref1}, it is judged that the load current steps up if Vₒ+V_{droop}<V_{ref1}. V_{ref1} can be set upon the empirical sensing value or upon the value of the equivalent series resistor R_{ESR} of the output capacitor, e.g., V_{ref1}=Vₒᵤₜ−¼*Iₒₘₐₓ*R_{ESR}, wherein Iₒₘₐₓ is the peak value of Iₛᵤₘ or an adjacent value of the peak value within the range of the load current and Vₒᵤₜ is a predetermined value of the output voltage. Similarly, it is seen that the load current steps down if Vₒ+V_{droop}>V_{ref2}, wherein V_{ref2} is set to be a reasonable value higher than V_{ref1}, e.g., V_{ref2}=Vₒᵤₜ+¼*Iₒₘₐₓ*R_{ESR}.

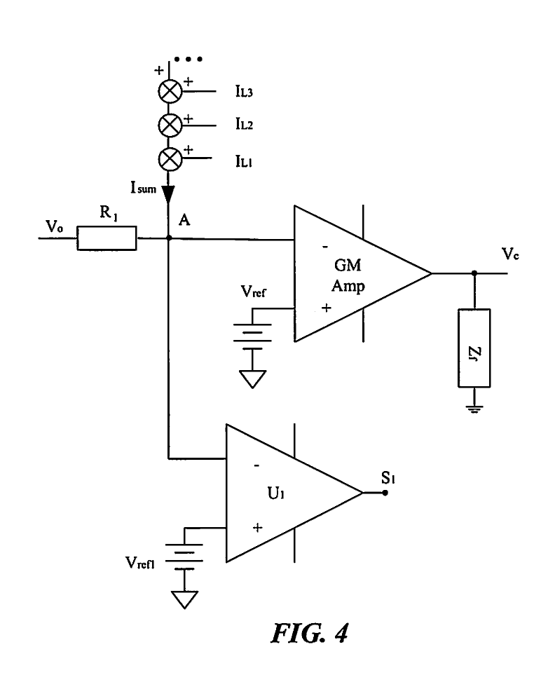

FIG. 4 shows a schematic diagram of a load transient sensing circuit using an active droop control circuit according to an embodiment of the present invention. The load transient sensing circuit comprises a comparator U₁, which receives a step-up reference voltage V_{ref1} at the positive input terminal. The negative input terminal of comparator U₁ is connected to a node A which receives the sum Iₛᵤₘ of n-phase inductor sampled currents, wherein Iₛᵤₘ=I_{L1}+I_{L2}+ . . . +I_{Ln}. A resistor R₁ is connected between the output terminal Vₒ of a power converter and Node A, wherein R₁=Rᵣₐₘₚ/a. Rᵣₐₘₚ is indicative of the slew rate of the output voltage in response to the variation of the output current and a is indicative of the sampling coefficient of the inductor current sampling circuit. Node A is also connected to the negative input terminal of a transconductive error amplifier GM Amp. The voltage at Node A is expressed as V_{A}=Vₒ+Iₛᵤₘ*R₁=Vₒ+V_{droop} as Iₛᵤₘ flows into Vₒ through R1. GM Amp compares Vₒ+V_{droop} with a reference voltage V_{ref} received at the positive input terminal and then outputs a compensation voltage V. The comparator U₁ compares Vₒ+V_{droop} with V_{ref1} and outputs a high-level load step-up signal S₁ when Vₒ+V_{droop}<V_{ref1}, indicative of a load step-up. The occurrence of the high-level signal S₁ is in accordance with the occurrence of the spike of Vₒ+V_{droop} at a load transient, producing a prompt sensing result. Vₒ+V_{droop} has no downward spike and holds low-level when no load transient occurs. In one embodiment, Iₛᵤₘ=I_{L}.

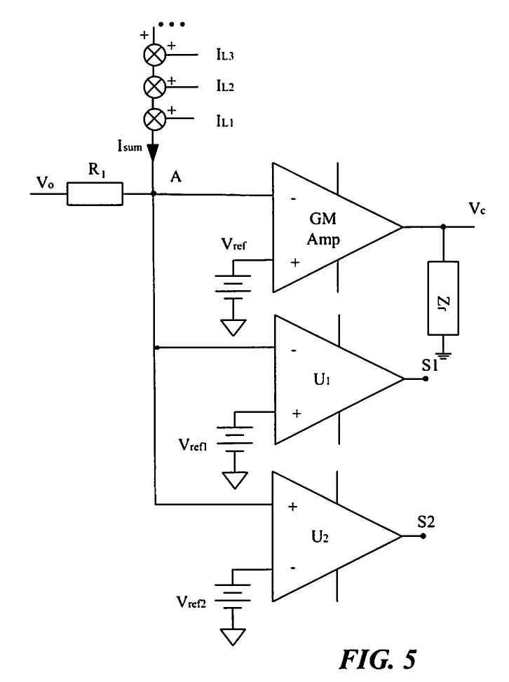

The load transient sensing circuit may further comprise a second comparator U₂ for sensing a load step-down according to another embodiment of the present invention. As shown in FIG. 5, the positive input terminal of the second comparator U₂ is connected to the negative input terminal of the first comparator U₁ and the negative input terminal of the second comparator U₂ receives a step-down reference voltage V_{ref2} set to be a value higher than V_{ref1}. When the load steps down, an upward spike appears in Vₒ+V_{droop}, which causes Vₒ+V_{droop}>V_{ref2} and U₂ outputs a high-level load step-down signal S₂ indicative of a load step-down. For a single-phase converter, Iₛᵤₘ=I_{L}. The load transient sensing circuit shown in FIG. 5 senses both the step-up and the step-down of the load at one time, wherein the load step-up signal and the load step-down signal are collectively named as the load transient signal.

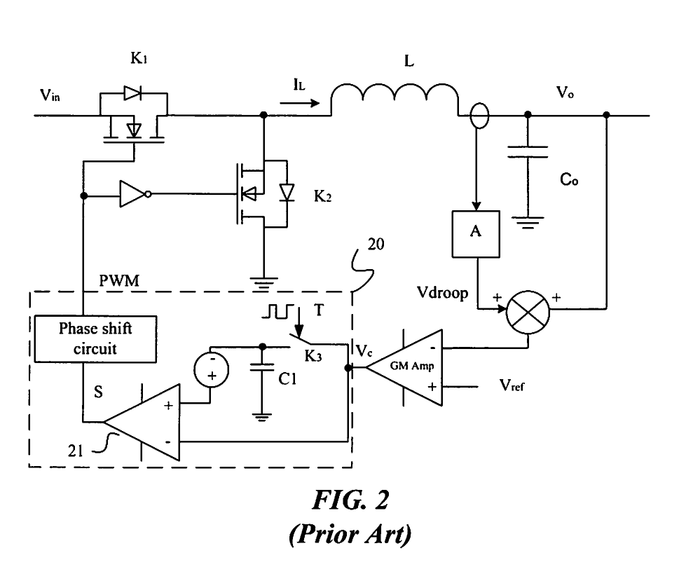

Compared with the prior-art load transient sensing circuit shown in FIG. 2, the load transient sensing circuits described above have simple structures and obtain the load transient signal only by the use of a comparator or comparators. Further, the load transient sensing circuits described above can promptly sense the load transient signal by directly comparing the sum of the output voltage and the active droop voltage with a reference voltage rather than comparing the difference of the sum of the output voltage and the active droop voltage over a certain time interval to judge the load transient. Thereby the load transient signal derived from the disclosed load transient sensing circuit has faster response time for controlling the parameters of the output voltage of a power converter.

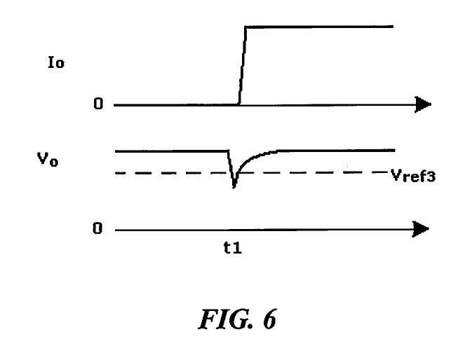

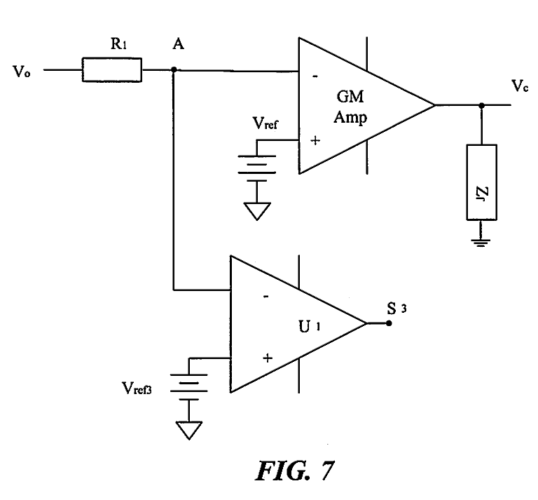

In another embodiment, a power converter without the active droop mode control can also use the load transient sensing circuit structure composed of the comparators described above. FIG. 6 shows a waveform diagram illustrating a load transient sensing method without using an active droop mode control of the present invention. In this condition, the waveform of the output voltage V₀ is shown in FIG. 6. Due to the existence of the equivalent series resistance ESR of the output capacitor, Vₒ has a spike at a load transient which appears as a downward spike when the load current I₀ steps up and appears as an upward spike when the load current I₀ steps down. By directly comparing V₀ with a reference voltage V_{ref3}, it indicates that the load steps up if Vₒ<V_{ref3}, wherein V_{ref3} can be set upon the empirical sensing value or upon the value of the equivalent series resistance R_{ESR} of the output capacitor, e.g., V_{ref3}=Vₒᵤₜ−¼*Iₒₘₐₓ*R_{ESR}. The load transient sensing method is achieved by using the comparator U₁ shown in FIG. 7 which receives a step-up reference voltage V_{ref3} at the positive input terminal and is connected to Node A at the negative input terminal. The voltage at said Node A equals to Vₒ due to the absence of the current across the load R₁. Node A is also connected to the negative input terminal of a transconductive error amplifier GM Amp for comparing the node voltage with a reference voltage V_{ref} to output a compensation voltage V_{c}. If Vₒ<V_{ref3}, the comparator U₁ outputs a high-level load step-up signal S₃ indicative of the step-up of the load. The occurrence of the high-level signal S₃ is in accordance with the occurrence of the spike of Vₒ at a load transient, producing a prompt sensing result. The comparator U₁ holds low-level when no load transient occurs.

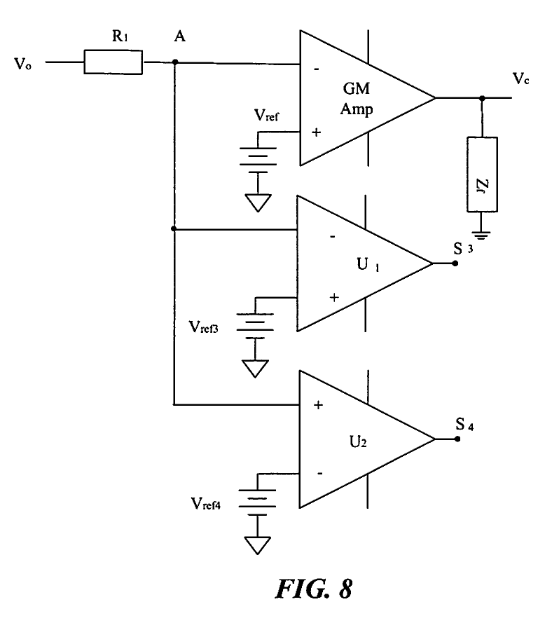

The load transient sensing circuit shown in FIG. 7 may further comprise a second comparator U₂. As shown in FIG. 8, the positive input terminal of the comparator U₂ is connected to the negative input terminal of the comparator U₁ and the negative input terminal of the comparator U₂ receives a step-down reference voltage V_{ref4} which is higher than V_{ref3}, e.g., V_{ref4}=Vₒᵤₜ+¼*Iₒₘₐₓ*R_{ESR}. When the load steps down, Vₒ has an upward spike causing Vₒ>V_{ref4}, and the comparator U₂ produces a high-level load step-down transient signal S₄ indicative of the step-down of the load. The load transient sensing circuit senses both the step-up and the step-down of the load at one time.

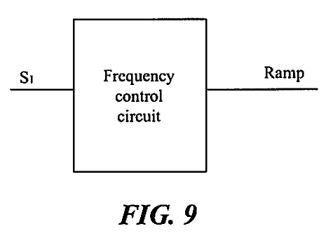

FIG. 9 shows a block diagram illustrating the load transient sensing circuit applied in the frequency control domain according to the present invention. As shown in FIG. 9, the frequency control circuit receives the load step-up signal S₁ shown in FIG. 4 and outputs a Ramp signal (ramp signal, the same below), wherein the Ramp signal is a triangle wave or a sawtooth wave whose frequency determines the switching frequency of the power converter. The frequency of the Ramp signal increases when the frequency control circuit senses a high-level signal S₁. In another embodiment, the frequency control circuit can receive both the load step-up signal S₁ shown in FIG. 4 and the load step-down signal S₂ shown in FIG. 5 at one time and increase the frequency of the Ramp signal when a high-level signal S₁ is sensed and decrease the frequency of the Ramp signal when a high-level signal S₂ is sensed.

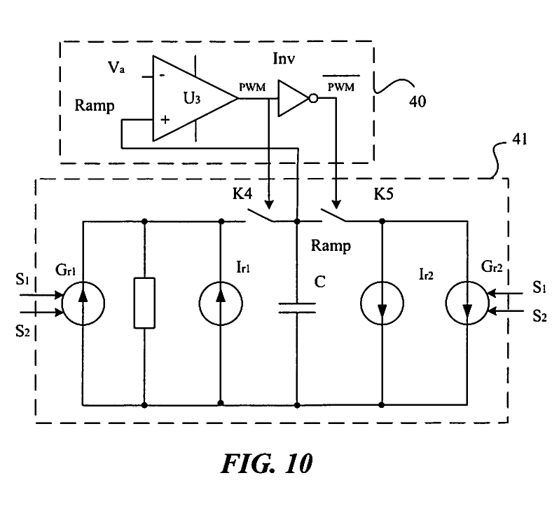

FIG. 10 shows a specific embodiment of the frequency control circuit. As shown in FIG. 10, the frequency control circuit 41 and the PWM generating circuit 40 work together to generate a PWM signal whose frequency changes in response to the change of the load. In the PWM generating circuit 40, the PWM comparator U₃ compares the signal Vₐ with the Ramp signal produced by the frequency control circuit 41, wherein the signal Vₐ is a compensation voltage V_{c} produced by an error amplifier in a voltage mode control and is a complex signal of the compensation voltage V_{c} and the current signal in a current mode control. The comparator U₃ outputs a PWM signal to control the state (ON or OFF) of the switch K₄ in the frequency control circuit 41 and the PWM signal is inverted by the inverter Inv to generate an inverse signal P̅W̅M̅ to control the state (ON or OF) of the switch K₅. The frequency control circuit 41 comprises a capacitor C, a charge-up current source Iᵣ₁, a discharge current source Iᵣ₂, a charge-up switch K₄, a discharge switch K₅, a charge-up controllable current source Gᵣ₁ and a discharge controllable current source Gᵣ₂, wherein Iᵣ₁ and Iᵣ₂ are current sources respectively with a constant value and Gᵣ₁ and Gᵣ₂ are current sources both controlled by the load step-up signal S₁ and the load step-down signal S₂. The currents of Gᵣ₁ and Gᵣ₂ increase, causing the charge rate or discharge rate for C to increase and also cause the frequency to increase when S₁ is high-level, resulting in a faster switching action. The currents of Gᵣ₁ and Gᵣ₂ decrease, causing the charge rate or discharge rate for C to decrease and also cause the frequency to decrease when S₂ is high, resulting in a slower switching action, thereby improving the system efficiency. In another embodiment, Gᵣ₁ or Gᵣ₂ are controlled only by one of the load step-up signal S₁ and the load step-down signal S₂. The currents of Gᵣ₁ and Gᵣ₂ may be hold the same or different.

The load step-up signal S₃ and the load step-down signal S₄ produced by the load transient sensing circuit shown in FIG. 7 and FIG. 8 can also be used in the frequency control circuit shown in FIG. 6 and the usage is the same as the signal S₁ and the signal S₂ described above.

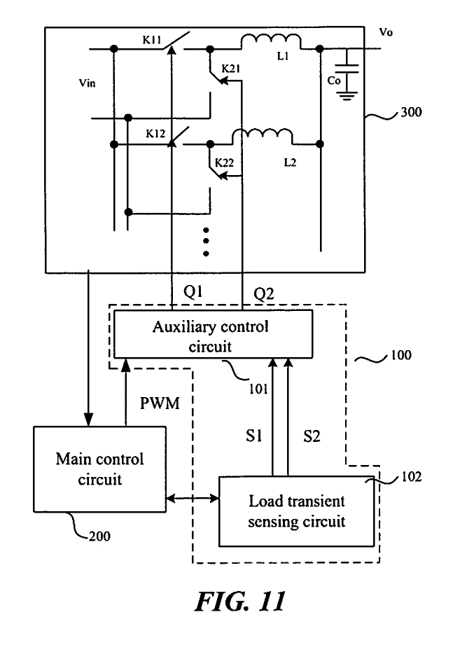

FIG. 11 shows a structural diagram illustrating the load transient sensing circuit applied in an overshoot eliminating device of a Buck converter. The overshoot eliminating device 100 comprising an auxiliary control circuit 101 and a load transient sensing circuit 102 is configured to reduce the change of the output voltage at a load transient. As shown in FIG. 11, the main circuit 300 of the Buck converter has a Buck topology which is single-phase or multiphase. The input voltage Vin is converted into a pulsed high and low level signal due to the alternately turning on and turning off of the high-side switches K11, K12, . . . , K1n and the low-side switches K21, K22, . . . , K2n (herein n is greater than or equals to 1) and is further converted into an output voltage Vₒ by being filtered through inductors L1, L2 . . . , and the filter capacitor Co. The main control circuit 200 shown in FIG. 11 receives signals such as the output voltage or the output current etc. of the main circuit 300 to generate a PWM signal for controlling the main circuit 300, wherein said main control circuit 200 may use voltage mode control, current mode control or other control methods. The auxiliary control circuit 101 receives the load step-up signal S₁ (or S₃) and the load step-down signal S₂ (or S₄) generated by the load transient sensing circuit 102. When S₁ or S₂ is high-level, namely when the load transient occurs, the overshoot eliminating device 100 shields the control of the main control circuit 200 to the main circuit 300 and generates signals Q₁ and Q₂ to control the switches in the main circuit 300. When S₁ and S₂ are low-level, namely during normal operation, the main circuit 300 is controlled by the main control circuit 200, which means Q₁ is the PWM signal and Q₂ is the inverse signal P̅W̅M̅ of the PWM signal in this case. The load transient sensing circuit 102 is as shown in FIG. 5 or FIG. 8, comprising a first comparator and a second comparator. The first comparator is connected to the output Node A at the negative input terminal and receives a first reference voltage (V_{ref1} or V_{ref3} shown respectively in FIG. 5 or FIG. 8) at the positive input terminal. The first comparator produces a load step-up signal. The second comparator is connected to the output Node A at the positive input terminal and receives a second reference voltage (V_{ref2} or V_{ref4} shown respectively in FIG. 5 or FIG. 8) at the negative input terminal. The second comparator produces a load step-down signal. For a multiphase Buck converter, when the load step-up signal S₁ or S₃ is high-level, the auxiliary control circuit 101 starts up and turns on all the high-side switches K11, K12, . . . , K1n etc. and turns off all the low-side switches K21, K22, . . . , K2n etc. to continue to charge the output capacitor Cₒ and compensate the step-down voltage Vₒ. When the load step-sown signal S₂ or S₄ is high-level, the auxiliary control circuit 101 starts up and turns off all the high-side switches and all the low-side switches K11, K21, K12, K22, . . . , K1n, K2n etc. to cut off the current path of the inductors L1, L2, . . . , Ln, forcing the charging of Cₒ to stop and preventing Vₒ from further increasing. The control duration of the auxiliary control circuit 101 to turn on the high-side switches can be synchronous with the duration of the high level load step-up signal, can be a predetermined fixed time or can be determined by comparing the output voltage Vₒ with a reference voltage V_{ref5}, that is to say, when Vₒ>V_{ref5}, the auxiliary control circuit 101 stops turning on the high-side switches and turning off the low-side switches, wherein V_{ref5} is a reference value which is nearly equal to or a little higher than the first reference voltage. In the same way, the control duration of the auxiliary control circuit 101 to turn off all the switches can be synchronous with the duration of the high level load step-down signal, can be a predetermined fixed time or can be determined by comparing the output voltage Vₒ with a reference voltage V_{ref6}, that is to say, when Vₑ<V_{ref6}, the auxiliary control circuit 101 stops turning off all the high-side and low-side switches, wherein V_{ref6} is a reference value which is nearly equal to or a little lower than the second reference voltage.

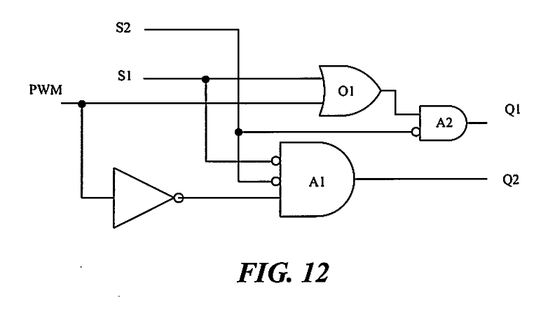

FIG. 12 shows a logic control circuit diagram illustrating the auxiliary control circuit 101 shown in FIG. 11. The logic control circuit receives a load step-up signal S₁ (or S₃), a load step-down signal S₂ (or S₄) and a PWM signal produced by the main control circuit 200 shown in FIG. 11 and outputs signals Q₁ and Q₂ for respectively controlling the high-side switches and the low-side switches. The signal S₁ and the PWM signal are supplied to an OR-gate O1 of which the output terminal is connected to an input terminal of an AND-gate A₂. The signal S₂ is inverted and then supplied to the other input terminal of A₂ which outputs a signal Q₁. The AND-gate Aₗ receives the inverse signal of S₁, the inverse signal of S₂ and the inverse signal of the PWM signal and outputs a signal Q₂. During normal operation, S₁ and S₂ are low level and the signals Q₁ and Q₂ are decided by the PWM signal. When S₁ is high level and S₂ is low level, the PWM signal is shielded, Q₁ is high level and Q₂ is low level in this case, accordingly, the high-side switches are turned on and the low-side switches are turned off. When S₁ is low level and S₂ is high level, the PWM signal is shielded, both Q1 and Q2 are low level in this case, accordingly, both the high-side switches and the low-side switches are turned off. In practical applications, the signals Q₁, Q₂ can drive the high-side switches and the low-side switches respectively through a driving circuit.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

I/We claim:

1. A load transient sensing circuit for a power converter, comprising:
an input terminal coupled to the output terminal of said power converter through a resistor; and
at least one comparator for comparing the voltage of said input terminal with at least one reference voltage to generate at least one load transient signal for controlling the parameters of the output voltage of said power converter.

2. The load transient sensing circuit as claimed in claim 1, wherein said power converter uses an active droop control and the voltage of said input terminal is the sum of an active droop voltage and said output voltage.

3. The load transient sensing circuit as claimed in claim 2, wherein said input terminal receives an inductor sampled current of said power converter and said active droop voltage is a voltage drop across said resistor produced by said inductor sampled current flowing through said resistor.

4. The load transient sensing circuit as claimed in claim 3, wherein said power converter is a single-phase converter or a multiphase converter, wherein said inductor sampled current is the sum of multiphase inductor sampled currents when said power converter is the multiphase converter.

5. The load transient sensing circuit as claimed in claim 1, wherein the voltage of said input terminal is the output voltage of said power converter.

6. The load transient sensing circuit as claimed in claim 1, wherein said at least one reference voltage is a step-up reference voltage and said at least one comparator outputs a high-level load step-up transient signal when the voltage of said input terminal is lower than the step-up reference voltage.

7. The load transient sensing circuit as claimed in claim 1, wherein said at least one reference voltage is a step-down reference voltage and said at least one comparator outputs a high-level load step-down transient signal when the voltage of said input terminal is higher than the step-down reference voltage.

8. The load transient sensing circuit as claimed in claim 1, wherein said at least one reference voltage further comprises a step-up reference voltage and a step-down reference voltage, wherein said at least one load transient signal further comprises a high-level load step-up transient signal and a high-level load step-down transient signal, wherein said at least one comparator further comprises:
a first comparator for comparing the voltage of said input terminal with the step-up reference voltage and outputting the high-level load step-up transient signal when the voltage of said input terminal is lower than the step-up reference voltage.
a second comparator for comparing the voltage of said input terminal with the step-down reference voltage and outputting the high-level load step-down transient signal when the voltage of said input terminal is higher than the step-down reference voltage.

9. A frequency control circuit for a power converter, wherein said frequency control circuit receives said at least one load transient signal as claimed in claim 1 so as to increase a system frequency when a load steps up or to decrease the system frequency when the load steps down.

10. The frequency control circuit as claimed in claim 9, wherein said frequency control circuit is a Ramp-signal generating circuit for receiving said at least one load transient signal of said load transient sensing circuit so as to produce a high-frequency Ramp signal when a load step-up transient signal is high-level and to produce a low-frequency Ramp signal when a load step-down transient signal is high-level, wherein the frequency of said Ramp signal controls the system frequency of said power converter.

11. An overshoot eliminating device for a Buck power converter having at least one high-side switch and at least one low-side switch, comprising:
a load transient sensing circuit comprising:
an input terminal coupled to the output terminal of said power converter through a resistor; and
at least one comparator for comparing the voltage of said input terminal with at least one reference voltage to generate at least one load transient signal for controlling the parameters of the output voltage of said power converter; and
an auxiliary control circuit for receiving said at least one load transient signal of said load transient sensing circuit so as to turn on said at least one high-side switch and to turn off said at least one low-side switch for a period of time when said auxiliary control circuit receives the high-level load step-up transient signal and to turn off said at least one high-side switch and at least one low-side switch when said auxiliary control circuit receives the high-level load step-down transient signal.

12. The overshoot eliminating device as claimed in claim 11, wherein the duration of on-time or off-time of said at least one high-side switch and the duration of off-time of said at least one low-side switch is consistent with the duration of said load transient signal.

13. The overshoot eliminating device as claimed in claim 11, wherein said auxiliary control circuit stops turning on said at least one high-side switch and turning off said at least one low-side switch when the output voltage of the Buck converter is higher than a first reference value and said auxiliary control circuit stops turning off said at least one high-side switch and said at least one low-side switch when the output voltage of said Buck converter is lower than a second reference value.
